(19) United States
(12) Patent Application Publication
(10) Pub. No.: US 2026/0120334 A1
(43) Pub. Date: Apr. 30, 2026

(54) REVERSIBLE COMPRESSION OF MEDIA ITEMS

(71) Applicant: Google LLC, Mountain View, CA (US)

(72) Inventors: Amir KAMALI, Mountain View, CA (US); Hossein TALEBI, Mountain View, CA (US); Nick TORRES, Mountain View, CA (US); Prachi PANPALIA, Mountain View, CA (US); Peyman MILANFAR, Mountain View, CA (US); Navin SARMA, Mountain View, CA (US); Keren YE, Mountain View, CA (US); Mauricio DELBRACIO, Mountain View, CA (US); Ignacio GARCIA, Mountain View, CA (US)

(73) Assignee: Google LLC, Mountain View, CA (US)

(21) Appl. No.: 19/383,455

(22) Filed: Nov. 7, 2025

Related U.S. Application Data
(63) Continuation-in-part of application No. 18/906,680, filed on Oct. 4, 2024.
(60) Provisional application No. 63/542,520, filed on Oct. 4, 2023.

(51) Int. Cl. G06T 9/00; G06N 3/0464; G06T 3/4046; G06T 3/4053

(52) U.S. Cl. CPC G06T 9/002; G06N 3/0464; G06T 3/4046; G06T 3/4053; G06T 2200/24

(57) ABSTRACT

A computer implemented method includes receiving a request to reversibly compress an original media item associated with a user account. In response to the request to reversibly compress, the method further includes generating a downscaled media item based on the original media item. The method further includes providing the original media item and the downscaled media item as input to a fine-tuning engine. The fine-tuning engine outputs a file that includes a set of modifications to weights to apply to a machine-learning model that is trained to generate high-resolution media items. The method further includes replacing the original media item with the downscaled media item in storage associated with the user account.

### CROSS-REFERENCE TO RELATED APPLICATIONS

This application is continuation-in-part under 35 U.S.C. § 120 of U.S. patent application Ser. No. 18/906,680, filed Oct. 4, 2024, entitled “Generation of High-Resolution Images,” which is a non-provisional application that claims priority under 35 U.S.C. § 119(e) to U.S. Provisional Patent Application No. 63/542,520 , titled “Generation of High-Resolution Images,” filed on Oct. 4, 2023. The contents of U.S. patent application Ser. No. 18/906,680 and U.S. Provisional Patent Application No. 63/542,520 are hereby incorporated by reference herein in its entirety.

### BACKGROUND

Users of smartphones and cloud-based photo storage services frequently face the challenge of exhausting their storage quotas. This issue is accelerated by the continually improving quality of smartphone cameras, which produce larger media files. When users reach their storage limit, it can lead to reduced engagement with the service, prompting them to either stop using the product or create new accounts to circumvent the limitation.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer implemented method includes receiving a request to reversibly compress an original media item associated with a user account. In response to the request to reversibly compress, the method further includes generating a downscaled media item based on the original media item. The method further includes providing the original media item and the downscaled media item as input to a fine-tuning engine. The fine-tuning engine outputs a file that includes a set of modifications to weights to apply to a machine-learning model that is trained to generate high-resolution media items. The method further includes replacing the original media item with the downscaled media item in storage associated with the user account.

In some embodiments, the method further comprises receiving a request to generate a restored media item from the downscaled media item; in response to the request to generate the restored media item, providing the downscaled media item and the file as input to the machine-learning model, where the set of modification to the weights in the file are applied to the machine-learning model; and generating, with the machine-learning model and based on the downscaled media item and the file, the restored media item, where the restored media item is substantially similar to the original media item. In some embodiments, the machine-learning model generates the restored media item by: dividing the downscaled media item into a plurality of tiles; for each tile of the plurality of tiles, generating a super resolution tile that includes one or more of a base super resolution layer, a face super resolution layer, a text super resolution layer, and combinations thereof, where the set of modification to the weights are applied to each corresponding layer during generation of each tile; and aggregating the super resolution tiles to form the restored media item. In some embodiments, the machine-learning model generates the restored media item by: generating a base super resolution layer; determining whether the downscaled media item includes a face; responsive to the downscaled media item including the face, outputting a face super resolution layer; and blending the base super resolution layer and the face super resolution layer to form the restored media item. In some embodiments, the machine-learning model generates the restored media item by: generating a base super resolution layer; determining whether the downscaled media item includes text; responsive to the downscaled media item including the text, outputting a text super resolution layer of the downscaled media item; and blending the base super resolution layer and the text super resolution layer to form the restored media item. In some embodiments, generating the downscaled media item includes reducing a size and a resolution of the original media item, and where the restored media item is generated to match the size and the resolution of the original media item.

In some embodiments, the method further includes prior to the fine-tuning engine outputting the file, freezing weights of the machine-learning model; and where the set of modifications to weights are matrices that, when applied to the weights of the machine-learning model, enable the machine-learning model to perform upscaling of the downscaled media item. In some embodiments, the method further comprises storing the downscaled media item in cloud storage.

A non-transitory computer-readable medium with instructions stored thereon that, when executed by one or more computers, cause the one or more computers to perform operations.

The operations include receiving a request to reversibly compress an original media item associated with a user account; in response to the request to reversibly compress, generating a downscaled media item based on the original media item; providing the original media item and the downscaled media item as input to a fine-tuning engine; outputting, with the fine-tuning engine, a file that includes a set of modifications to weights to apply to a machine-learning model that is trained to generate high-resolution media items; and replacing the original media item with the downscaled media item in storage associated with the user account.

In some embodiments, the operations further include receiving a request to generate a restored media item from the downscaled media item; in response to the request to generate the restored media item, providing the downscaled media item and the file as input to the machine-learning model, where the set of modification to the weights in the file are applied to the machine-learning model; and generating, with the machine-learning model and based on the downscaled media item and the file, the restored media item, where the restored media item is substantially similar to the original media item. In some embodiments, the machine-learning model generates the restored media item by: dividing the downscaled media item into a plurality of tiles; for each tile of the plurality of tiles, generating a super resolution tile that includes one or more of a base super resolution layer, a face super resolution layer, a text super resolution layer, and combinations thereof, where the set of modification to the weights are applied to each corresponding layer during generation of each tile; and aggregating the super resolution tiles to form the restored media item. In some embodiments, the machine-learning model generates the restored media item by: generating a base super resolution layer; determining whether the downscaled media item includes a face; responsive to the downscaled media item including the face, outputting a face super resolution layer; and blending the base super resolution layer and the face super resolution layer to form the restored media item. In some embodiments, the machine-learning model generates the restored media item by: generating a base super resolution layer; determining whether the downscaled media item includes text; responsive to the downscaled media item including the text, outputting a text super resolution layer of the downscaled media item; and blending the base super resolution layer and the text super resolution layer to form the restored media item. In some embodiments, generating the downscaled media item includes reducing a size and a resolution of the original media item, and where the restored media item is generated to match the size and the resolution of the original media item.

A system comprises a processor; and a memory coupled to the processor, with instructions stored thereon that, when executed by the processor, cause the processor to perform operations. The operations include receiving a request to reversibly compress an original media item associated with a user account; in response to the request to reversibly compress, generating a downscaled media item based on the original media item; providing the original media item and the downscaled media item as input to a fine-tuning engine; outputting, with the fine-tuning engine, a file that includes a set of modifications to weights to apply to a machine-learning model that is trained to generate high-resolution media items; and replacing the original media item with the downscaled media item in storage associated with the user account.

In some embodiments, the operations further include receiving a request to generate a restored media item from the downscaled media item; in response to the request to generate the restored media item, providing the downscaled media item and the file as input to the machine-learning model, where the set of modification to the weights in the file are applied to the machine-learning model; and generating, with the machine-learning model and based on the downscaled media item and the file, the restored media item, where the restored media item is substantially similar to the original media item. In some embodiments, the machine-learning model generates the restored media item by: dividing the downscaled media item into a plurality of tiles; for each tile of the plurality of tiles, generating a super resolution tile that includes one or more of a base super resolution layer, a face super resolution layer, a text super resolution layer, and combinations thereof, where the set of modification to the weights are applied to each corresponding layer during generation of each tile; and aggregating the super resolution tiles to form the restored media item. In some embodiments, the machine-learning model generates the restored media item by: generating a base super resolution layer; determining whether the downscaled media item includes a face; responsive to the downscaled media item including the face, outputting a face super resolution layer; and blending the base super resolution layer and the face super resolution layer to form the restored media item. In some embodiments, the machine-learning model generates the restored media item by: generating a base super resolution layer; determining whether the downscaled media item includes text; responsive to the downscaled media item including the text, outputting a text super resolution layer of the downscaled media item; and blending the base super resolution layer and the text super resolution layer to form the restored media item.

### BRIEF DESCRIPTION OF THE DRAWINGS

FIG. 1 is a block diagram of an example network environment, according to some embodiments described herein.

FIG. 2 is a block diagram of an example computing device, according to some embodiments described herein.

FIG. 3A is an example user interface that includes an option for displaying a super resolution version of an image after the image is captured, according to some embodiments described herein.

FIG. 3B is an example user interface that includes options for specifying a level of magnification, according to some embodiments described herein.

FIG. 3C is an example user interface that displays a high-resolution version of the image that was generated after the image was captured, according to some embodiments described herein.

FIG. 4 is a block diagram of an example super resolution module, according to some embodiments described herein.

FIG. 5 illustrates a flowchart of an example method to generate custom degradations, according to some embodiments described herein.

FIG. 6 is an example of the generalized Gaussian blur, according to some embodiments described herein.

FIG. 7 is a block diagram of an example super resolution machine-learning model that generates a high-resolution portion of an image, according to some embodiments described herein.

FIG. 8 illustrates a flowchart of an example method to generate a high-resolution image, according to some embodiments described herein.

FIG. 9 illustrates an example of text enhancement, according to some embodiments described herein.

FIGS. 10A-10B illustrate an example original image and an example high-resolution image, according to some embodiments described herein.

FIGS. 11A-11C illustrates an example of how tiles are aggregated to output a high-resolution version of an original image, according to some embodiments described herein.

FIGS. 12A-12C illustrate example user interfaces that include options for compressing media items, according to some embodiments described herein.

FIG. 13 illustrates a block diagram of an example process for generating a downscaled media item from an original media item, according to some embodiments described herein.

FIGS. 14A-14D illustrate example user interfaces that include options for generating a restored media item, according to some embodiments described herein.

FIG. 15 illustrates a block diagram of an example process for generating a restored media item, according to some embodiments described herein.

FIG. 16 illustrates a flowchart of an example method to generate a high-resolution image after an original image was captured, according to some embodiments described herein.

FIG. 17 illustrates a flowchart of an example method to generate a downscaled media item, according to some embodiments described herein.

### DETAILED DESCRIPTION

### Overview

As storage space becomes an issue on smartphones and cloud-storage, a user is faced with several options. First, the user may capture media items with lower quality. However, users are often dissatisfied with this type of compromise. Second, the user may select traditional image compression, but user adoption has been low because users are reluctant to compress their photos due to the irreversible loss of quality.

The media application described herein leverages generative AI to significantly reduce the storage footprint of media (e.g., images and videos) while retaining the ability to restore the media to a quality nearly indistinguishable from the original. The media application first downscales media items (e.g., to save up to 80% of storage space on a user device and/or cloud storage). The media application performs fine-tuning of a machine-learning model (e.g., a super resolution machine-learning model) that is personalized for particular media items by providing pairs of media items where an original media item is paired with a corresponding downscaled media item. The fine-tuning results in a file (e.g., a patch), which describes updated weight values that are personalized based on the user's media items. The file and the downscaled media items are stored in cloud storage.

When a user wants to view an upscaled version of a media item, the user's custom-trained file is applied to the machine-learning model to restore the media item. This process can restore the media item to its original dimensions with high fidelity, and in some cases, may even enhance the original quality. As a result, the user benefits from a compression process that reduces storage demands of each media item, while preserving the option to restore any media item to a high-quality version.

### Environment

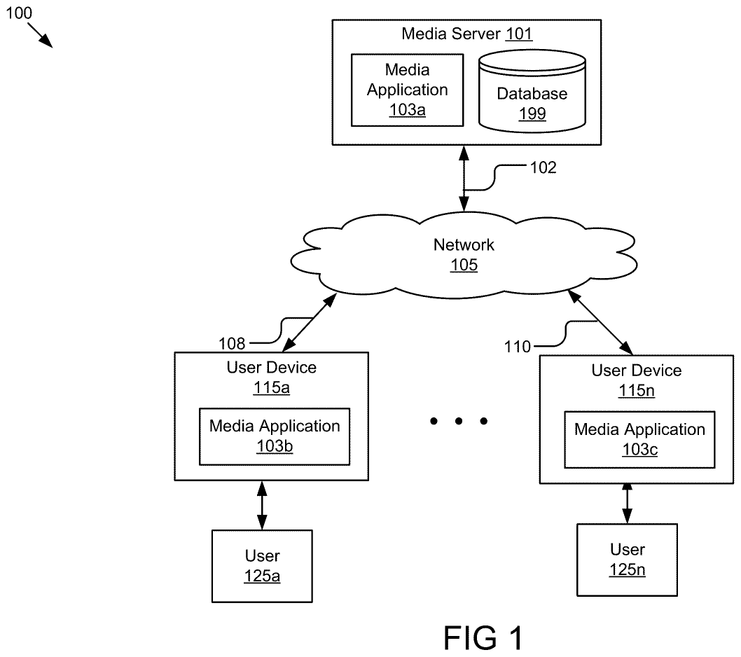

FIG. 1 illustrates a block diagram of an example environment 100. In some embodiments, the environment 100 includes a media server 101, a user device 115a, and a user device 115n coupled to a network 105. Users 125a, 125n may be associated with respective user devices 115a, 115n. In some embodiments, the environment 100 may include other servers or devices not shown in FIG. 1. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number.

The media server 101 may include a processor, a memory, and network communication hardware. In some embodiments, the media server 101 is a hardware server. The media server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the media server 101 sends and receives data to and from one or more of the user devices 115a, 115n via the network 105. The media server 101 may include a media application 103a and a database 199.

The database 199 may store machine-learning models, training data sets, media items associated with a user account, etc. The database 199 may also store social network data associated with users 125, user preferences for the users 125, etc. In some embodiments, the database 199 includes cloud storage for media items associated with user accounts.

The user device 115 may be a computing device that includes a memory coupled to a hardware processor. For example, the user device 115 may include a mobile device, a tablet computer, a mobile telephone, a wearable device, a head-mounted display, a mobile email device, a portable game player, a portable music player, a reader device, or another electronic device capable of accessing a network 105.

In the illustrated implementation, user device 115a is coupled to the network 105 via signal line 108 and user device 115n is coupled to the network 105 via signal line 110. The media application 103 may be stored as media application 103b on the user device 115a and/or media application 103c on the user device 115n. Signal lines 108 and 110 may be wired connections, such as Ethernet, coaxial cable, fiber-optic cable, etc., or wireless connections, such as Wi-Fi®, Bluetooth®, or other wireless technology. User devices 115a, 115n are accessed by users 125a, 125n, respectively. The user devices 115a, 115n in FIG. 1 are used by way of example. While FIG. 1 illustrates two user devices, 115a and 115n, the disclosure applies to a system architecture having one or more user devices 115.

The media application 103 may be stored on the media server 101 or the user device 115. In some embodiments, the operations described herein are performed on the media server 101 or the user device 115. In some embodiments, some operations may be performed on the media server 101 and some may be performed on the user device 115. Performance of operations is in accordance with user settings. For example, the user 125a may specify settings that operations are to be performed on their respective user device 115a and not on the media server 101. With such settings, operations described herein are performed entirely on user device 115a and no operations are performed on the media server 101. Further, a user 125a may specify that images and/or other data of the user is to be stored only locally on a user device 115a and not on the media server 101. With such settings, no user data is transmitted to or stored on the media server 101. Transmission of user data to the media server 101, any temporary or permanent storage of such data by the media server 101, and performance of operations on such data by the media server 101 are performed only if the user has agreed to transmission, storage, and performance of operations by the media server 101. Users are provided with options to change the settings at any time, e.g., such that they can enable or disable the use of the media server 101.

Machine learning models (e.g., neural networks or other types of models), if utilized for one or more operations, are stored and utilized locally on a user device 115, with specific user permission. Server-side models are used only if permitted by the user. Further, a trained model may be provided for use on a user device 115. During such use, if permitted by the user 125, on-device training of the model may be performed. Updated model parameters may be transmitted to the media server 101 if permitted by the user 125, e.g., to enable federated learning. Model parameters do not include any user data.

The media application 103 receives a request to reversibly compress an original media item (e.g., an image or a video) associated with a user account. For example, the media application 103 may generate a user interface that displays media items associated with the user and, responsive to the user device 115 and/or cloud storage being at or close to a limit of storage space, the user interface includes a suggestion for the user to reversibly compress one or more media items to increase the storage space. The media application 103 generates a downscaled media item based on the original media item.

In order for the compression of the downscaled media item to be reversible, a fine-tuning engine uses the original media item and the downscaled media item to generate a set of modifications to weights to apply to a machine-learning model that is trained to generate high-resolution media items. The media application 103 replaces the original media item with the downscaled media item in storage of the user device 115 and/or in cloud storage to increase the storage space.

In some embodiments, the media application 103 may be implemented using hardware including a central processing unit (CPU), a field-programmable gate array (FPGA), an application-specific integrated circuit (ASIC), machine learning processor/co-processor, any other type of processor, or a combination thereof. In some embodiments, the media application 103a may be implemented using a combination of hardware and software.

### Computing Device

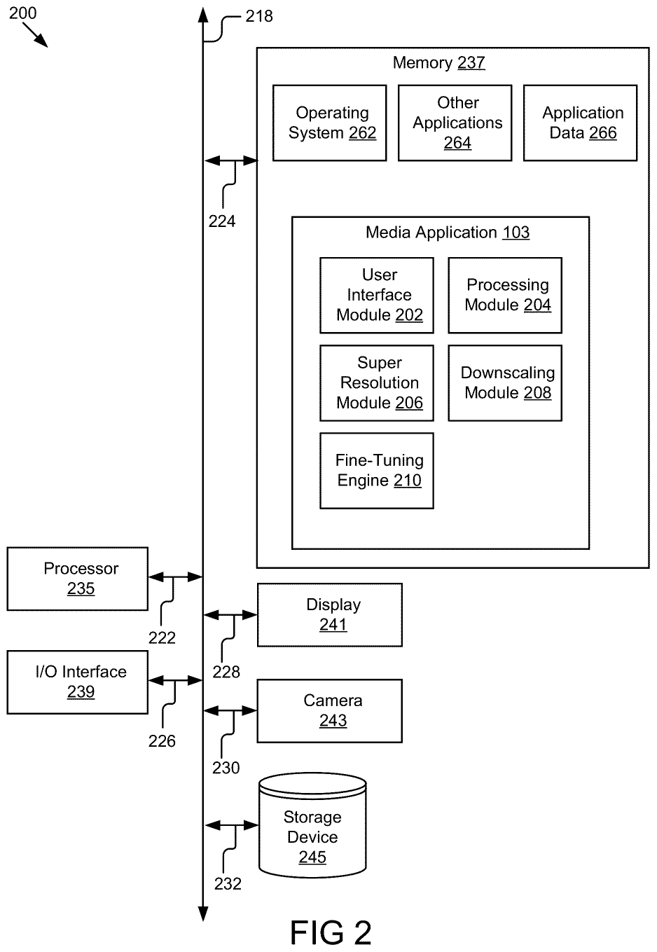

FIG. 2 is a block diagram of an example computing device 200 that may be used to implement one or more features described herein. Computing device 200 can be any suitable computer system, server, or other electronic or hardware device. In one example, computing device 200 is media server 101 used to implement the media application 103a. In another example, computing device 200 is a user device 115.

In some embodiments, computing device 200 includes a processor 235, a memory 237, an input/output (I/O) interface 239, a display 241, a camera 243, and a storage device 245 all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the display 241 may be coupled to the bus 218 via signal line 228, the camera 243 may be coupled to the bus 218 via signal line 230, and the storage device 245 may be coupled to the bus 218 via signal line 232.

Processor 235 can be one or more processors and/or processing circuits to execute program code and control basic operations of the computing device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some embodiments, processor 235 may include one or more co-processors that implement neural-network processing. In some embodiments, processor 235 may be a processor that processes data to produce probabilistic output, e.g., the output produced by processor 235 may be imprecise or may be accurate within a range from an expected output. Processing need not be limited to a particular geographic location or have temporal limitations. For example, a processor may perform its functions in real-time, offline, in a batch mode, etc. Portions of processing may be performed at different times and at different locations, by different (or the same) processing systems. A computer may be any processor in communication with a memory.

Memory 237 is typically provided in computing device 200 for access by the processor 235, and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including a media application 103.

The memory 237 may include an operating system 262, other applications 264, and application data 266. Other applications 264 can include, e.g., an image library application, an image management application, an image gallery application, communication applications, web hosting engines or applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

The application data 266 may be data generated by the other applications 264 or hardware of the computing device 200. For example, the application data 266 may include images used by the image library application and user actions identified by the other applications 264 (e.g., a social networking application), etc.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 245), and input/output devices can communicate via I/O interface 239. In some embodiments, the I/O interface 239 can connect to interface devices such as input devices (keyboard, pointing device, touchscreen, microphone, scanner, sensors, etc.) and/or output devices (display devices, speaker devices, printers, monitors, etc.).

Some examples of interfaced devices that can connect to I/O interface 239 can include a display 241 that can be used to display content, e.g., images, video, and/or a user interface of an output application as described herein, and to receive touch (or gesture) input from a user. For example, display 241 may be utilized to display a user interface that includes a graphical guide on a viewfinder. Display 241 can include any suitable display device such as a liquid crystal display (LCD), light emitting diode (LED), or plasma display screen, cathode ray tube (CRT), television, monitor, touchscreen, three-dimensional display screen, or other visual display device. For example, display 241 can be a flat display screen provided on a mobile device, multiple display screens embedded in a glasses form factor or headset device, or a monitor screen for a computer device.

Camera 243 may be any type of image capture device that can capture images and/or video. In some embodiments, the camera 243 captures images or video that the I/O interface 239 transmits to the media application 103.

The storage device 245 stores data related to the media application 103. For example, the storage device 245 may store a training data set that includes labeled images, a machine-learning model, output from the machine-learning model, etc.

### Media Application

FIG. 2 illustrates an example media application 103, stored in memory 237. The media application 103 includes a user interface module 202, a processing module 204, a super resolution module 206, a downscaling model 208, and a fine-tuning engine 210.

The user interface module 202 generates graphical data for displaying a user interface. The user interface may include options for capturing media items using the camera 243 of the computing device 200 or options for receiving media items from the media server 101 via the I/O interface 239. The user interface displays one or more media items, options for modifying the one or more media items, options for compressing the one or more media items, and options for generating one or more restored media items from one or more downscaled media items.

The user interface module 202 obtains permission from a user to modify and/or compress media items. A user may be provided with controls allowing the user to make an election as to both if and when systems, programs, or features described herein may enable collection of user information (e.g., identification of the user in an image, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

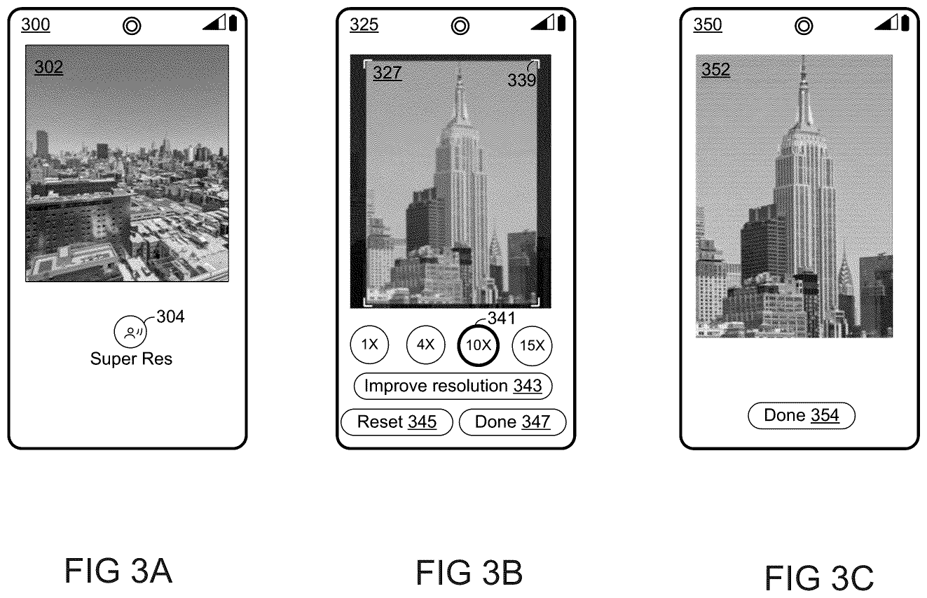

While examples below may be with reference to an image, other types of media items may be used, such as videos. The user interface module 202 generates a user interface to display an original image. FIG. 3A is an example user interface 300 of an original image 302, according to some embodiments described herein. The user interface 300 includes a super resolution button 304 that a user may select to initiate a process for the media application 103 to generate a high-resolution portion of an original image.

Once a user selects the super resolution button 304 in FIG. 3A, the media application 103 may display the example user interface 325 in FIG. 3B, according to some embodiments described herein. The user interface 325 includes options for selecting a portion 327 of the original image. In this example, the user interface 325 provides edges 339 that are adjustable to include a larger or smaller area of the original image to select dimensions for the portion 327 of the original image to be modified.

The user may select a magnification level. In this example, the magnification levels are 1× (i.e., no change), 4×, 10×, and 15× but any magnification level can be used. In this example, the user selects a 10× magnification button 341 and selects the improve resolution button 343. Alternatively, the user could select the reset button 345 to revert to the original image 302 of FIG. 3A or unselect the 10× magnification button 341 and select the done button 347 to obtain a cropped portion 327 of the original image.

FIG. 3C is an example user interface 350 that displays a high-resolution portion 352 of the original image, according to some embodiments described herein. If the user is satisfied, the user may select the done button 354.

The processing module 204 may perform pre-processing or post processing of an image. For example, the processing module 204 may perform pre-processing of an original image or a high-resolution portion of an original image by changing the brightness, performing auto enhancement, blurring the original image or portions of the original image (e.g., the background), removing objects from the image, cropping the image, etc.

In some embodiments, the processing module 204 generates original metadata for an image, such as whether the image includes a face and/or text. The processing module 204 may determine optimal artificial resolution core specifications (ARCS) for downscaling and upscaling the image.

The super resolution module 206 includes an adversarial-based real image super-resolution machine-learning model that is trained for post-capture super resolution features, such that the super resolution machine-learning model can generate higher resolution versions for arbitrary input images. The super resolution module 206 may include a set of machine-learning models that are each trained for different types of image features. Examples of the machine-learning models include a base super resolution machine-learning model that upscales general image content, a text super resolution machine-learning model that identifies text in images and generates a higher resolution version of the text, and a face super resolution machine-learning model that specializes in faces and generates a higher resolution version of the faces. In some embodiments, the face super resolution machine-learning model specializes in human faces. In some embodiments, the base model is applied to every input image while the specialized models are triggered based on the content of the specific image. For example, an image with human faces and with no text is analyzed by the face super resolution machine-learning model and not analyzed by the text super resolution machine-learning model.

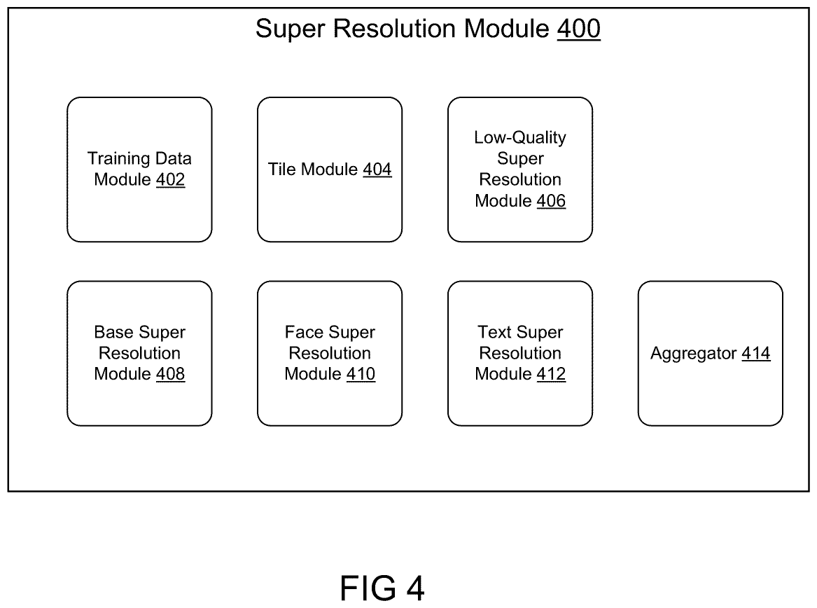

Turning to FIG. 4, a block diagram of an example super resolution module 400 is illustrated, according to some embodiments described herein. The super resolution module 400 includes a training data module 402, a tile module 404, a low-quality super resolution module 406, a base super resolution module 408, a face super resolution module 410, a text super resolution module 412, and an aggregator 414.

One challenge in generating super-resolution images and in restoring images is gathering real ground-truth low-resolution high-resolution pairs. It is technologically difficult to acquire pairs of photographs with, for example, different camera configurations. Previous attempts have resulted in color/alignment mismatch between the reference and low-resolution captures. Other techniques have included attempting to fully simulate low-resolution images and other degradations on high-quality images. However, the results are unsatisfactory because different objects and different parts of a scene may undergo different degradations, such as different types of blur and noise.

In some embodiments, the training data module 402 generates training data by performing multiple degradations on reference high-quality frames (images). The training data module 402 may generate a lower-resolution image by extracting a random crop of an input image, applying an inverse gamma correction to the input image based on a random gamma correction value, augmenting the input image by randomly shifting pixel values by a constant factor, blurring the input image by adding noise to the input image, and/or applying gamma correction to the input image.

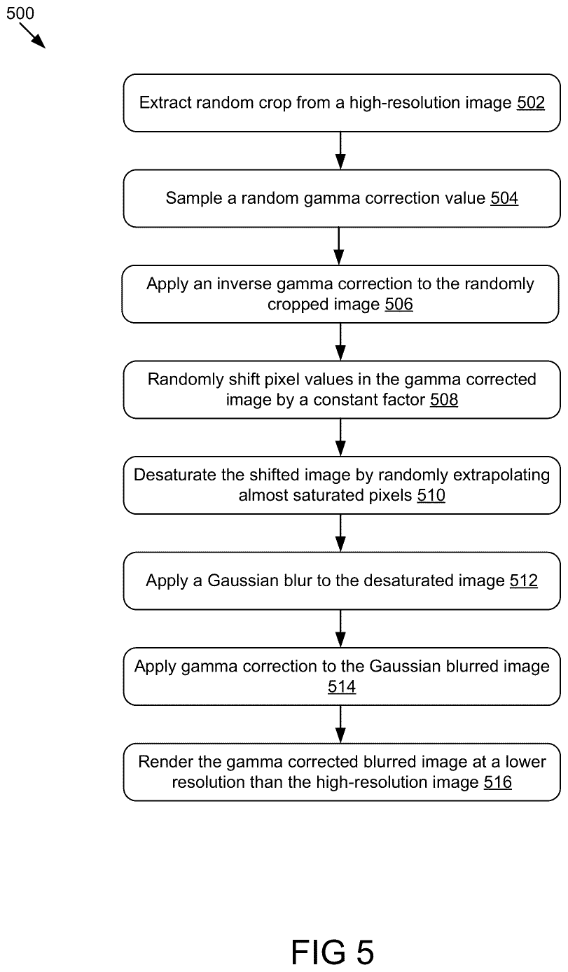

In some embodiments, the training data module 402 performs a set of specific actions to generate custom degradations. FIG. 5 illustrates a flowchart of an example method 500 to generate custom degradations, according to some embodiments described herein. The method 500 may be performed by the media application 103.

The method may begin with block 502. At block 502, a random crop is extracted from a high-resolution image. The random crop is advantageous to train the machine-learning model using a realistic scenario because different parts of an image may undergo different degradations and therefore have different blur and noise. In some embodiments, the method 500 further includes randomly flipping and/or rotating the high-resolution image and/or the randomly cropped image. Block 502 may be followed by block 504.

At block 504, a random gamma correction value is sampled. Block 504 may be followed by block 506.

At block 506, an inverse gamma correction is applied to the randomly cropped image based on the random gamma correction value. Block 506 may be followed by block 508.

At block 508, pixel values in the gamma corrected image are randomly shifted by a constant factor. Randomly shifting the pixel values by a constant factor is performed for data augmentation. Block 508 may be followed by block 510.

At block 510, the shifted image is desaturated by randomly extrapolating almost saturated pixels. In some embodiments, almost saturated pixels are defined by applying a threshold value, such as pixels that are at a particular intensity, such as a value between 240-255. In some embodiments, the almost saturated pixels are multiplied by a random factor greater than or equal to one to make the value out of the range of 0-255. Block 510 may be followed by block 512.

At block 512, a Gaussian blur is applied to the desaturated image. Gaussian blur creates a hazier image by convolving an image with a Gaussian function. In some embodiments, the Gaussian blur is based on a minimum sigma value where sigma reflects a variance of the blurring, a maximum sigma value, a minimum rho parameter where rho represents a smoothing of the blurring, a maximum rho parameter, and/or a gamma value where gamma is used to control an overall brightness of an image.

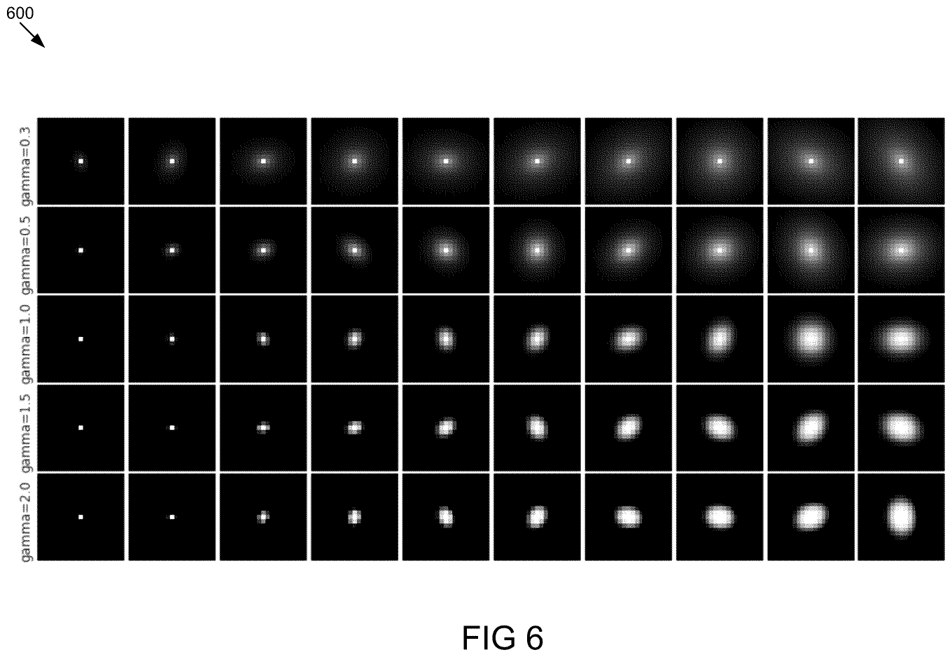

FIG. 6 is an example of the generalized Gaussian blur of differently sized kernels 600 as a function of different gamma values and orientations, according to some embodiments described herein. The Gaussian blur kernels 600 includes examples with a gamma range of between 0.3 and 2.0 where the brighter value of 2.0 results in more pixels in the space being brighter than at lower gamma values. The different orientations of the blur kernels are more discernable as the size of the kernels increases from left to right.

Applying the Gaussian blur may include downsampling the Gaussian blurred image and/or adding noise to the Gaussian blurred image, such as Poisson+Gaussian noise, white noise, colored noise, etc. In some embodiments, the noise includes a specified readout noise minimum, a readout noise maximum, a readout noise decay, a shot noise minimum, a shot noise maximum, a minimum Gaussian blur to generate colored noise, a maximum Gaussian blur to generate colored noise, a minimum fraction of white noise, and and/or a maximum fraction of white noise. Block 512 may be followed by block 514.

At block 514, a gamma correction is applied to the Gaussian blurred image. Block 514 may be followed by block 516.

At block 516, the gamma corrected blurred image is rendered at a lower resolution than the high-resolution image. In some embodiments, the rendering includes achieving a target low resolution, such as an image that is four times smaller than the high-resolution image. In some embodiments, the method 500 further includes performing image compression (e.g., JPEG compression) with a random quality factor that is sampled from a predefined distribution.

The machine-learning models implemented in any of modules 406, 408, 410, and 412 use the low-resolution image and the high-resolution image as training data. In some embodiments, the machine-learning models are trained with the low-resolution image representing an input image and the high-resolution image representing a ground truth image.

In some embodiments, the super resolution module 400 includes one or more machine-learning models that receive a portion of an original image as input and output a high-resolution image. The one or more trained machine-learning models may include one or more model forms or structures. For example, model forms or structures can include any type of neural-network, such as a linear network, a deep-learning neural network that implements a plurality of layers (e.g., “hidden layers” between an input layer and an output layer, with each layer being a linear network), a convolutional neural network (e.g., a network that splits or partitions input data into multiple tiles, processes each tile separately using one or more neural-network layers, and aggregates the results from the processing of each tile), a sequence-to-sequence neural network (e.g., a network that receives as input sequential data, such as words in a sentence, frames in a video, etc. and produces as output a result sequence), etc.

In some embodiments, the one or more machine-learning models are diffusion models. Diffusion models work by corrupting the training data by progressively adding Gaussian noise, removing details in the data until it becomes noise, and training a neural network to reverse the corruption process. In some embodiments, the diffusion models are cascaded diffusion models that include a pipeline of multiple diffusion models that generate images of increasing resolution, beginning with a standard diffusion model at the lowest resolution, followed by one or more super-resolution diffusion models that successively upsample the image and add higher resolution details.

The model form or structure may specify connectivity between various nodes and organization of nodes into layers. For example, nodes of a first layer (e.g., an input layer) may receive data as input data or application data. Such data can include, for example, one or more pixels per node, e.g., when the trained model is used for analysis, e.g., of a target image and one or more source images. Subsequent intermediate layers may receive as input, output of nodes of a previous layer per the connectivity specified in the model form or structure. These layers may also be referred to as hidden layers. A final layer (e.g., output layer) produces an output of the one or more machine-learning models. For example, the output layer may output the composite image. In some embodiments, model form or structure also specifies a number and/or type of nodes in each layer.

In different embodiments, the trained one or more machine-learning models can each include one or more models. One or more of the models may include a plurality of nodes, arranged into layers per the model structure or form. In some embodiments, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some embodiments, the computation performed by a node may also include applying a step/activation function to the adjusted weighted sum. In some embodiments, the step/activation function may be a nonlinear function. In various embodiments, such computation may include operations such as matrix multiplication. In some embodiments, computations by the plurality of nodes may be performed in parallel, e.g., using multiple processors cores of a multicore processor, using individual processing units of a graphics processing unit (GPU), or special-purpose neural circuitry. In some embodiments, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM).

In some embodiments, the one or more trained machine-learning models may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using training data, to produce a result.

Training may include applying supervised learning techniques. In supervised learning, the training data can include a plurality of inputs (e.g., low-resolution images obtained by the method of FIG. 5, etc.) and a corresponding ground truth output for each input (e.g., a ground truth high-resolution image, etc.). Based on a comparison of the output of the model (a higher resolution image generated based on the input low-resolution image) with the ground truth output (the ground truth high-resolution image), values of the weights are automatically adjusted, e.g., in a manner that increases a probability that the model produces the ground truth output for the composite image. In some embodiments, the training data may be different for each type of model. For example, a base super resolution machine-learning model may be trained with a variety of types of ground truth high-resolution images, a face super resolution machine-learning model may be trained with ground truth high-resolution images that include faces, and a text super resolution machine-learning model may be trained with ground truth high-resolution images that include text.

In various embodiments, one or more trained machine-learning models each include a set of weights, or embeddings, corresponding to the model structure. In some embodiments, the one or more trained machine-learning models may each include a set of weights that are fixed, e.g., downloaded from a server that provides the weights. In various embodiments, the one or more trained machine-learning models may each include a set of weights, or embeddings, corresponding to the model structure. In embodiments where data is omitted, the super resolution module 400 may generate one or more trained machine-learning models that are based on prior training, e.g., by a developer of the machine-learning model, by a third-party, etc. In some embodiments, the one or more trained machine-learning models may each include a set of weights that are fixed, e.g., downloaded from a server that provides the weights.

In some embodiments, one or more of the machine-learning models are trained using a combination of multiple losses. The losses may include an L1 loss between a generated image and a target image, perceptual loss using image features (e.g., features from a VGG 19 convolutional neural network that implements 19 layers), L2 color mismatch loss, and an adversarial loss. The weights of the different loss terms are tuned to produce realistic details without introducing significant alterations of the color and other undesired artifacts, such as strong hallucinations, grid artifacts, etc.

In some embodiments, some machine-learning models produce noticeable color artifacts that are hard to control and predict. To mitigate these artifacts, the super resolution module 400 trains the machine-learning model using a chroma loss that penalizes differences in the chroma ultraviolet (UV) space. Since human vision is less sensitive to high-resolution color details, the super resolution module 400 enforces an L2 loss between the generated image and the target high-resolution directly in the UV color space. The penalization may be performed in the color space while the luma (grayscale) component is unconstrained.

In previous techniques, the perceptual loss measures the discrepancy between convolutional network with multiple layers (e.g., 19 layers) extracted features on the generated image and the features extracted on the target image. To boost high-frequency content and produce an improved generated image, the super resolution module 400 computes the target reference convolutional network with multiple layers features on a sharpened target image. The target image is sharpened using an unsharp mask filter before extracting the reference features. As a result, the final sharpness of the generated image is finely controlled, and images are produced with higher contrast.

In some embodiments, the super resolution module 400 is run on a mobile device. One consideration for running the super resolution module 400 on mobile devices is that the mobile devices may be constrained by an amount of available memory and processing power. In some embodiments, the input processing size is restricted to small images, such as 256×256 input images. In some embodiments, the super resolution module 400 includes a tile module 404 that splits the original image into a plurality of tiles (e.g., of 256×256 pixels, or other suitable size) and enables machine-learning processing of larger images based on a tile-based inference, where a machine-learning model is tasked with generating a respective high-resolution image for each tile. To control the amount of needed memory and to make the inference faster (e.g., avoid bottlenecks), the tile module 404 segments a portion of an input image into tiles, which may be overlapping or non-overlapping (e.g., from resolutions of 128×128 to 512×512). The tile module 404 processes each tile individually and, in some embodiments, can process a plurality of tiles in parallel.

In some embodiments, the machine-learning models are quantized to 16 or 8 bits to reduce latency and memory usage. In some embodiments, quantization refers to setting the weights of individual nodes of the neural network the forms the machine-learning models to an 8-bit or 16-bit value. By quantizing the machine-learning models (limiting the precision of the weight for a node), the total sizes of the machine-learning models (number of nodes x bits per node) are reduced, enabling the machine-learning models to be used on mobile devices or other devices with low processing/memory capacity. This is done by using quantization-aware-training (QAT). In some embodiments, the super resolution module 400 trains the machine-learning models using a 32-bit float (weight values for neural network nodes are 32-bit floating point numbers) as a baseline model and then performs about 50,000 steps with a lower learning rate and QAT. This step significantly improves the quality of the generated results when running a quantized model (e.g., where node weights are represented as 8-bit or 16-bit floating point numbers, with lower precision than the original 32-bit values). In some embodiments, the machine-learning model uses Brain Floating Point 16 (bfloat16) and 8-bit integers (int8) quantization instead of floating-point numbers.

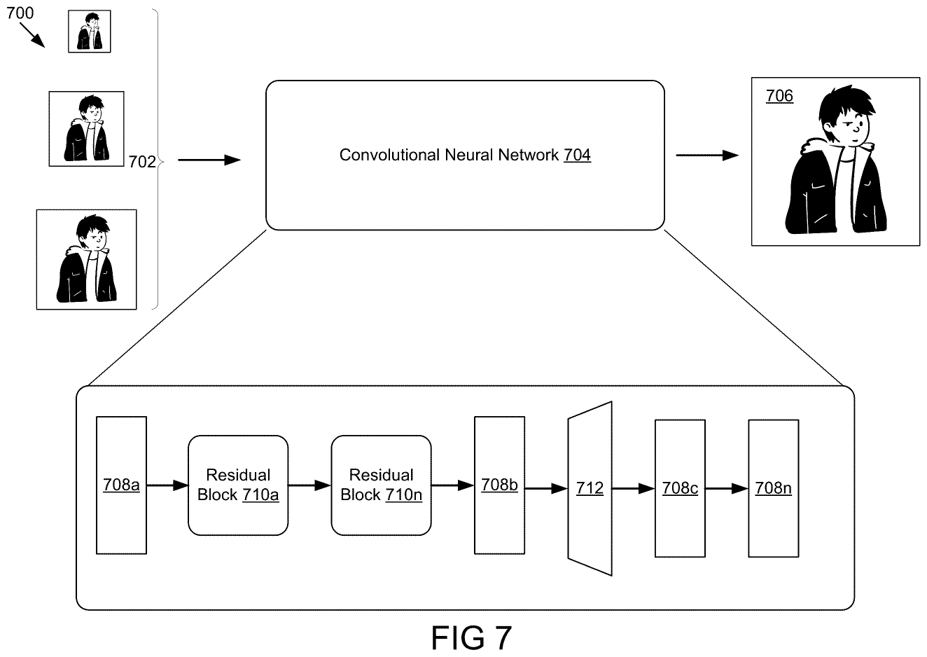

FIG. 7 is a block diagram of an example super resolution machine-learning model 700 that generates a high-resolution portion of an image, according to some embodiments described herein. The super-resolution machine-learning model 700 may include a base super resolution machine-learning model, a face super resolution machine-learning model, and/or a text super resolution machine-learning model.

The super resolution machine-learning model 700 is a convolutional neural network 704 that receives a plurality of lower-resolution input images 702 (e.g., 64×64 pixels, 128×128 pixels, etc.) and outputs a higher-resolution image 706 (e.g., 2048×1152 pixels). The convolutional neural network 704 may generate the higher-resolution image 706 from a single lower resolution input image 702. In some embodiments, the convolutional neural network 704 is an adversarial based super resolution machine-learning model that includes a series of convolutional layers 708a, 708b, 708c, 708n with residual blocks 710a, 710n between the first two convolutional layers 708a, 708b. In some embodiments, the residual blocks 710 are Residual-in-Residual Dense Blocks (RRDB). The number of residual blocks 710 may be kept to a lower number (e.g., seven residual blocks 710) to reduce the number of parameters in the super resolution machine-learning model 700 and to improve the latency, where latency is the time from providing the input image to the super resolution machine-learning model 700 to obtaining an output image from the super resolution machine-learning model 700. The convolutional layers 708 may be densely connected where each convolutional layer 708 is concatenated with its outputs. The convolutional neural network 704 also includes an upsampling layer 712 that increases the lower-resolution input images 702 to a desired higher-resolution image 706.

Continuing with FIG. 4, the super resolution module 400 includes the low-quality super resolution module 406, the base super resolution module 408, the face super resolution module 410, and the text super resolution module 412. The super resolution module 400 receives an input image that is associated with a quality resolution value. If the resolution value is below a resolution threshold value, the low-quality super resolution module 406 generates an output image. If the resolution value meets the threshold value, the base super resolution module 408 generates a base super resolution layer.

The low-quality super resolution module 406 performs unblurring and upsampling of portions of original images that are determined to be low quality, for example, that fail to meet a resolution threshold value. For higher quality images, the base super resolution module 408 generates a base super resolution layer, the face super resolution module 410 generates a face super resolution layer if the portion of the original image includes one or more faces, and the text super resolution module 412 generates a text super resolution layer if the portion of the original image includes text.

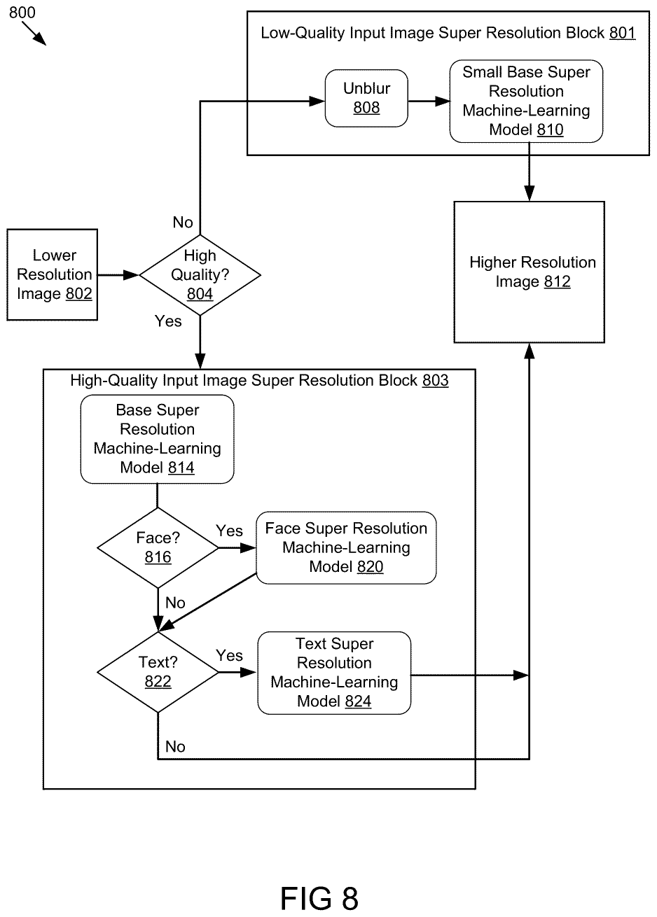

FIG. 8 illustrates an example flowchart of a method 800 to generate a high-resolution image, according to some embodiments described herein. The method 800 may be performed by the media application 103 in FIG. 1. A super resolution module receives a lower resolution image 802. A classifier determines 804 whether the lower resolution image 802 is high quality. In some embodiments, the high quality is determined based on a threshold resolution value. For example, the threshold resolution value may be 300 pixels per inch (PPI) or 300 dots per inch (DPI).

If the classifier determines 804 that the lower resolution image 802 is low quality, the high-quality input image super resolution block 803 may introduce artifacts or unexpected results. Responsive to the lower resolution image 802 being determined to be low quality, the lower resolution image 802 is received by the low-quality input image super resolution block 801. The low-quality input image super resolution block 801 may perform unblurring 808 of the lower resolution image 802 and use a small base super resolution machine-learning model 810, which is a lighter version of the base super-resolution machine-learning model 814. The small base super resolution machine-learning model 810 upscales the unblurred image to obtain a higher resolution image 812.

If the classifier determines 804 that the lower resolution image 802 is high quality, the lower resolution image 802 is provided to the high-quality input image super resolution block 803. The high-quality input image super resolution block 803 implements a base super resolution machine-learning model 814, such as the super resolution machine-learning model 700 illustrated in FIG. 7. The base super resolution machine-learning model 814 may be trained on the training dataset generated by the training data module 402. The base super resolution machine-learning model 814 outputs a super resolution base layer.

A classifier determines 816 whether the lower resolution image 802 includes one or more faces. In some embodiments, the faces are limited to human faces. In some embodiments, the faces may include human faces, animal faces, etc. If the lower resolution image 802 includes a face, the high-quality input image super resolution block 803 implements a face super resolution machine-learning model 820, such as the super resolution machine-learning model 700 illustrated in FIG. 7 that is trained to improve the quality of faces in higher resolution images.

The face super resolution machine-learning model 820 is an adversarial based super-resolution machine-learning model, similar to the base super resolution machine-learning model 814, but trained with a dataset focused on images that include one or more faces. In some embodiments, the face super resolution machine-learning model 820 determines whether the face is a good candidate for processing before applying the face super resolution machine-learning model 820 to the face. For example, a good candidate may be determined based on a blurriness score, a size (e.g., how many pixels the face image covers), etc. If the image is too blurry or the face image size is too large or too small, the face super resolution machine-learning model 820 is not applied. The training dataset is also generated by a combination of multiple degradations on images that include faces, and images having no degradation and limited resolution. The face super resolution machine-learning model 820 outputs a face super resolution layer.

A classifier determines 822 if the lower resolution image 802 includes text. If the lower resolution image 802 includes text, the high-quality input image super resolution block 803 implements a text super resolution machine-learning model 824, such as the super resolution machine-learning model 700 illustrated in FIG. 7 that is trained to magnify text content and improve the quality of text in higher resolution images.

The text super resolution machine-learning model 824 is an adversarial based super-resolution machine-learning model, similar to the base super resolution machine-learning model 814, but trained with a dataset focused on text images (or images having text). The training dataset is also generated by a combination of multiple degradations, and images having no degradation and limited resolution. The text super resolution machine-learning model 824 outputs a text super resolution layer.

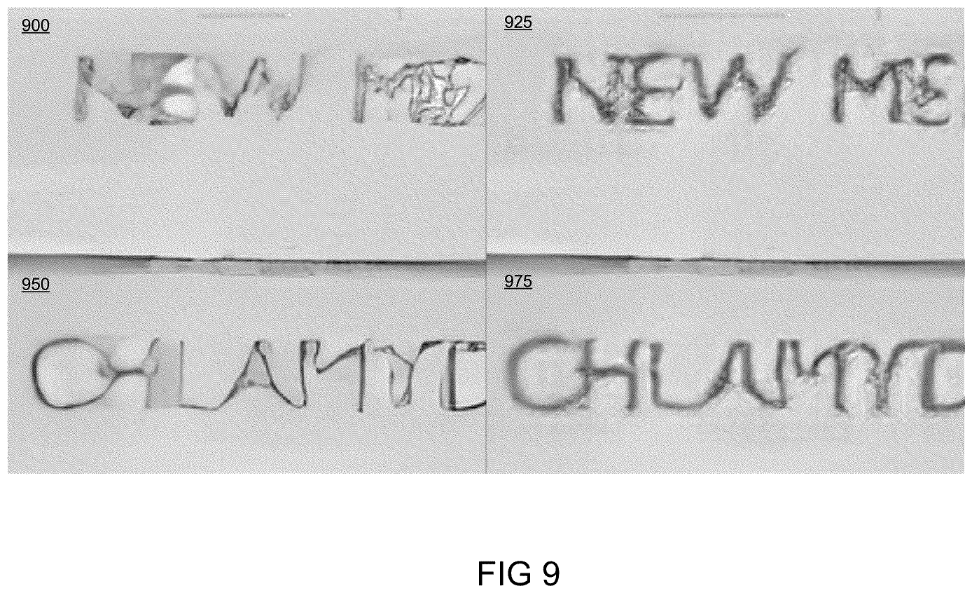

FIG. 9 illustrates examples of text enhancement, according to some embodiments described herein. A first version of a first image 900 and a first version of a second image 950 were output by the base super resolution machine-learning model 814. A second version of a first image 925 and a second version of a second image 975 were output by the text super resolution machine-learning model 824. Because the text super resolution machine-learning model 824 is specifically trained on text in images, the text super resolution machine-learning model 824 outputs higher-quality images than the base super resolution machine-learning model 814.

If the lower resolution image 802 did not include a face or text, the base super resolution layer is used as the higher resolution image 812. If the lower resolution image 802 included a face and not text, the base super resolution layer is blended with the face super resolution layer to form the higher resolution image 812. For example, the face super resolution layer may include portions of the face that were enhanced, and the edges of the face are blended with the base layer. In some embodiments, the colors of the face layer are adjusted to be consistent with the colors of the base layer before blending.

If the lower resolution image 802 included text and not a face, the base super resolution layer is blended with the text super resolution layer to form the higher resolution image 812. For example, the text super resolution layer may include text that was enhanced, and the edges of the text are blended with the base layer. In some embodiments, the colors of the text layer are adjusted to be consistent with the colors of the base layer before blending.

If the lower resolution image 802 included text and a face, the base super resolution layer, the text super resolution layer, and the face super resolution layer are blended to form the higher resolution image 812. In some embodiments, the colors of the face layer and the text layer are adjusted to be consistent with the colors of the base layer before blending.

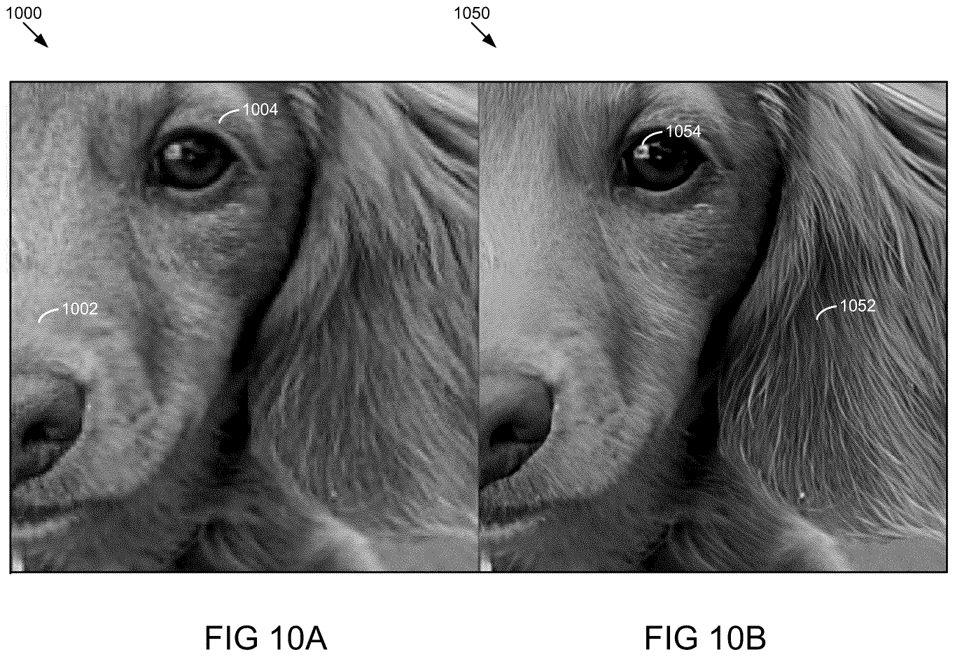

FIGS. 10A-10B illustrate an example original image 1000 and an example high-resolution image 1050, according to some embodiments described herein. The original image 1000 is an input image with a blurry appearance in some areas, such as near the nose 1002, and a pixelated appearance in other areas, such as near the eye 1004. The high-resolution image 1050 includes more refined details that make the hairs in the dog's ears 1052 look particularly distinct and the reflection 1054 in the dog's eye is sharp in comparison to eye 1004 in the original image 1000.

The aggregator 414 receives independently generated high-resolution tiles from different modules in the super resolution module 400 depending on the type of content in a tile. The aggregator 414 aggregates the super resolution tiles into a single high-resolution image, e.g., by combining the tiles in the same layout in which the original image was split into tiles. The aggregator 414 performs a final aggregation by using an average (e.g., a weighted average) of the super resolution tiles. The final configuration of the tile size, overlapped region size, and weighted mask may be optimized for each user device to trade-off quality, consistency, and performance.

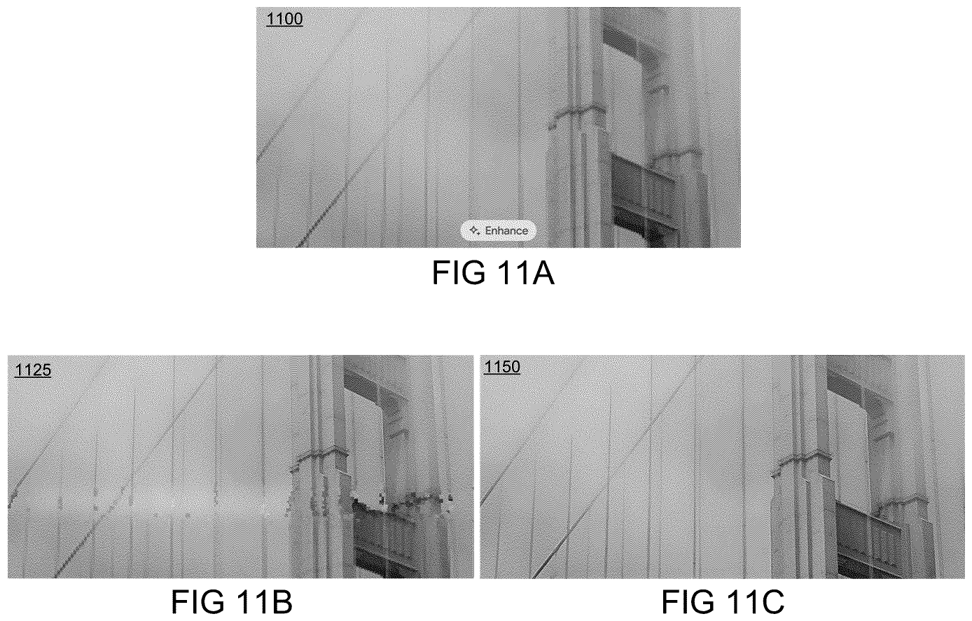

In some embodiments, instead of providing the high-resolution portion of the original image at one time, the aggregator 414 updates the user interface after each tile or a group of tiles are processed, such as in the examples illustrated in FIG. 11. FIGS. 11A-11C illustrates an example of how tiles are aggregated to output a high-resolution version of an original image, according to some embodiments described herein. In FIG. 11A, the input image 1100 is provided to the super resolution module 400. FIG. 11B illustrates an output image 1125 that illustrates the process of replacing tiles from the input image 1100 in FIG. 11A with tiles from the high-resolution output image 1125. FIG. 11C illustrates a completed high-resolution output image 1150 where all high-resolution regions are incorporated.

The downscaling module 208 receives an original media item from the user interface module 202 and generates a downscaled media item from the original media item. Generating a downscaled media item may include reducing a size and a resolution of the media item. In some embodiments, the downscaling module 208 performs the downscaling. In some embodiments, the downscaling module 208 uses a separate component for performing the downscaling. For example, the downscaling module 208 stored on a user device 115 may request that the media server 101 perform downscaling on the original media item.

The fine-tuning engine 210 performs fine-tuning of the machine-learning model trained by the super resolution module 206. For example, the fine-tuning engine 210 may use a low-rank adaptation (LoRA). In some embodiments, the fine-tuning engine 210 receives the original media item and the downscaled media item. The fine-tuning engine 210 freezes weights of the machine-learning model and generates a file (e.g., a patch) that includes modifications to the weights associated with the machine-learning model. The modifications may apply to a subset of the weights associated with the machine-learning model, which advantageously reduces the computational cost and the GPU memory requirement of performing fine-tuning of the machine-learning model.

The file may include matrices with the modifications to the weights, such as low-rank matrices, that adjust the weights of the machine-learning model. For example, the matrices may have a single column and, therefore, a rank of 1. In some embodiments, the modifications to the weights are applied to each layer of the machine-learning model during generation of the restored media item. As a result of applying the modifications of weights to the machine-learning model, the machine-learning model generates a restored media item from the downscaled media item that is substantially similar to the original media item.

### User Interfaces

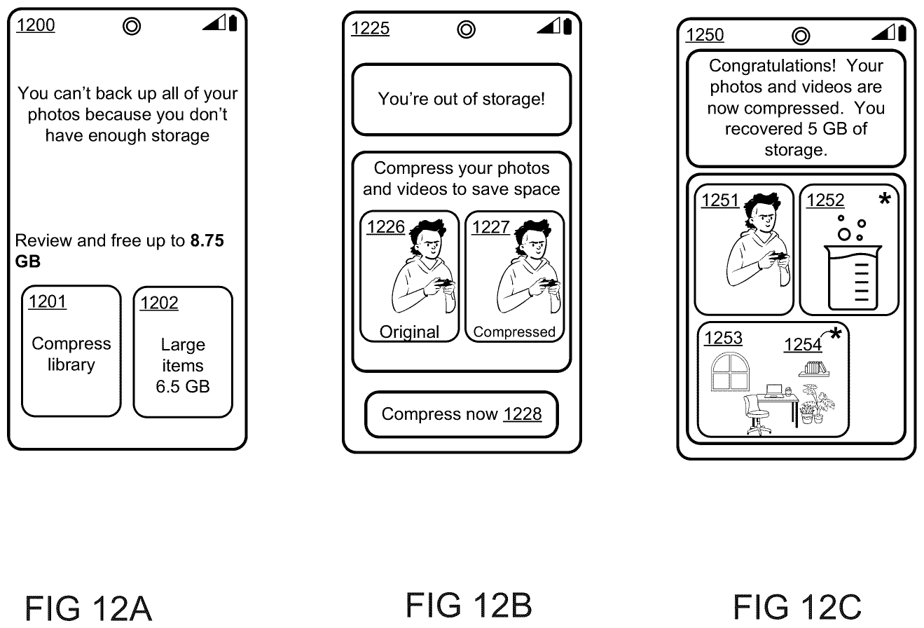

FIGS. 12A-12C illustrate example user interfaces 1200, 1225, 1250 that include options for compressing media items, according to some embodiments described herein. The various user interfaces 1200, 1225, 1250 of FIG. 12 may be generated by the user interface module 202.

FIG. 12A illustrates a first user interface 1200 that is generated by the user interface module 202 in response to determining that a user account has run out of storage. The storage may be associated with a user device 115 or part of cloud storage. The first user interface 1200 includes a first option 1201 for compressing a user's entire library of media items and a second option 1202 for compressing large media items. The second option 1202 includes an indication of how much storage will be saved by compressing the large media items.

FIG. 12B illustrates a second user interface 1225 that is generated by the user interface module 202 in response to determining that a user account has run out of storage. In this example, the user interface module 202 displays an example of an original image 1226 and a compressed image 1227 to illustrate the qualitative differences between the images. Selection of a compress now button 1228 causes the user interface module 202 to provide different options for compressing media items. For example, a user may compress all media items, a subset based on size, discrete media items within a library, etc.

FIG. 12C illustrates a third user interface 1250 after discrete media items have been compressed. The user interface 1250 includes three media items 1251, 1252, and 1253. The media items that were compressed include an indicator. For example, the third media item 1253 includes an indicator 1254 that resembles an asterisk.

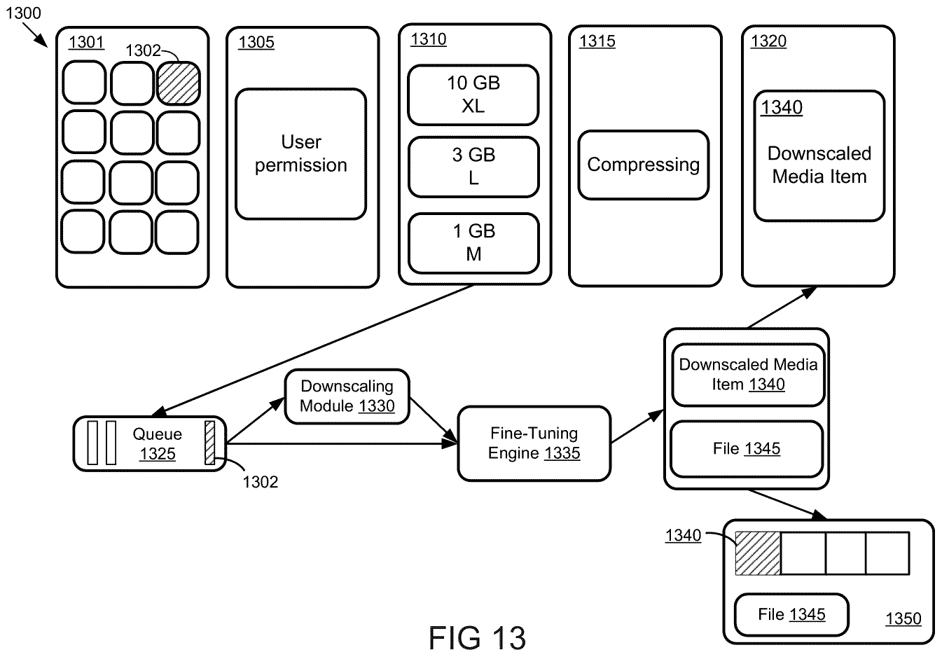

FIG. 13 illustrates a block diagram 1300 of an example process for generating a downscaled media item from an original media item, according to some embodiments described herein. A user interface 1301 of a user device includes original media items, such as original media item 1302. A user requests compression of one or more of the media items. The user interface 1305 is updated to display an option for obtaining user permission. For example, the user may confirm that the media items are used to perform fine-tuning of a machine-learning model. The user interface 1310 is updated to display groupings of media items based on their sizes. For example, a user account may include extra large media items that constitute 10 gigabyte (GB) of storage, large media items that constitute 3 GB of storage, and medium media items that constitute 1 GB of storage. A user may select one or more of the options. For example, the user may select compression of the extra large media items but leave the large media items and the medium media items in their original states.

While the media items are processed, the user interface 1315 is updated to show that the media items are currently being compressed. The media items (including original media item 1302) are processed by a queue 1325. Each media item is provided to a downscaling module 1330, which generates a downscaled media item from an original media item. The original media item and the downscaled media item are provided to a fine-tuning engine 1335. The fine-tuning engine 1335 generates a file 1345 (e.g., a patch) that includes a set of modifications to weights of a machine-learning model. The downscaled media item 1340 is paired with the file 1345 (e.g., in the form of metadata associated with the media item), which are displayed in a user interface 1320 of the user device and are stored in cloud storage 1350. The file 1345 represents a cumulative outcome of training each media item within the user's library. The training occurs continuously as the queue 1325 processes the media items. In some embodiments, multiple files 1345 are saved where each file is associated with a different type of machine-learning model (e.g., a first machine-learning model that is trained to enhance text, a second model that is trained to enhance faces, etc.). The cloud storage 1350 is continuously populated with additional media items and modifications to the file 1345 as the process continues.

In some embodiments, the original media item 1302 is associated with original metadata that is used to generate the downscaled media item 1340 and later to generate a restored media item. For example, the metadata may include information about content in the original media item 1302, such as whether it includes a face and/or text. In some embodiments, the metadata includes artificial intelligence resolution core specifications (ARCS) for downscaling and upscaling. For example, ARCS may include a dimension of an image, an image format, a minimum resolution, depth, whether the image has been downscaled or upscaled, whether the image has been encoded or decoded and if so by what particular models. ARCS are computationally advantageous for making the process more efficient and creating a cost savings in storage and CPU time. For example, if the original media item 1302 is a screenshot image, it is typically stored in a PNG format and may contain text, and so a higher resolution margin for downscaling or a specific machine-learning model is trained on text due to the risk of the screenshot image becoming irreversibly corrupted if it is excessively reduced. In another example, photographs of people may not be enhanced by a machine-learning model that is trained on text, but the media item may be enhanced by a machine-learning model that is trained on faces.

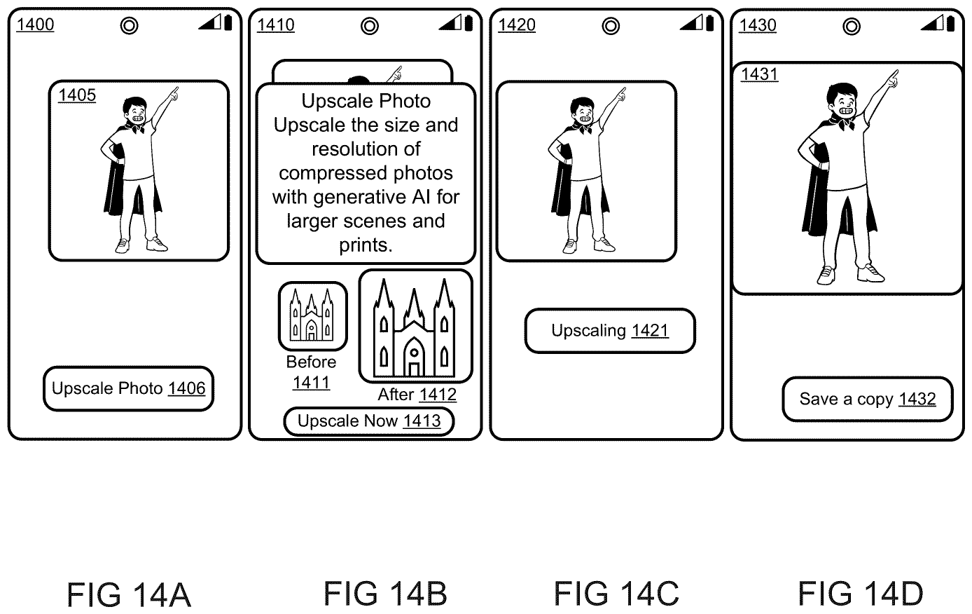

FIGS. 14A-14D illustrate example user interfaces 1400, 1410, 1420, 1430 that include options for generating a restored media item, according to some embodiments described herein. The various user interfaces of FIG. 14 may be generated by the user interface module 202.

FIG. 14A illustrates a first user interface 1400 of a downscaled image 1405. In some embodiments, each time a user selects a media item from their library, the media item is displayed with an upscale photo button 1406 (or an upscale video button). FIG. 14B is displayed responsive to the user selecting the upscale photo button 1406.

FIG. 14B illustrates a second user interface 1410 with information about how upscaling an image works. For example, the size and resolution of a downscaled image is increased by using generative AI. The second user interface 1410 includes a comparison of a before image 1411 of a downscaled image of a church and an after image 1412 of a restored image of the church. FIG. 14C is displayed responsive to the user selecting the upscale now button 1413.

FIG. 14C illustrates a third user interface 1420 that includes a status update that upscaling 1421 is occurring.

FIG. 14D illustrates a fourth user interface 1430 that is displayed once the restored image 1431 is generated. The fourth user interface 1430 includes a save a copy button 1432 for saving the restored image 1431.

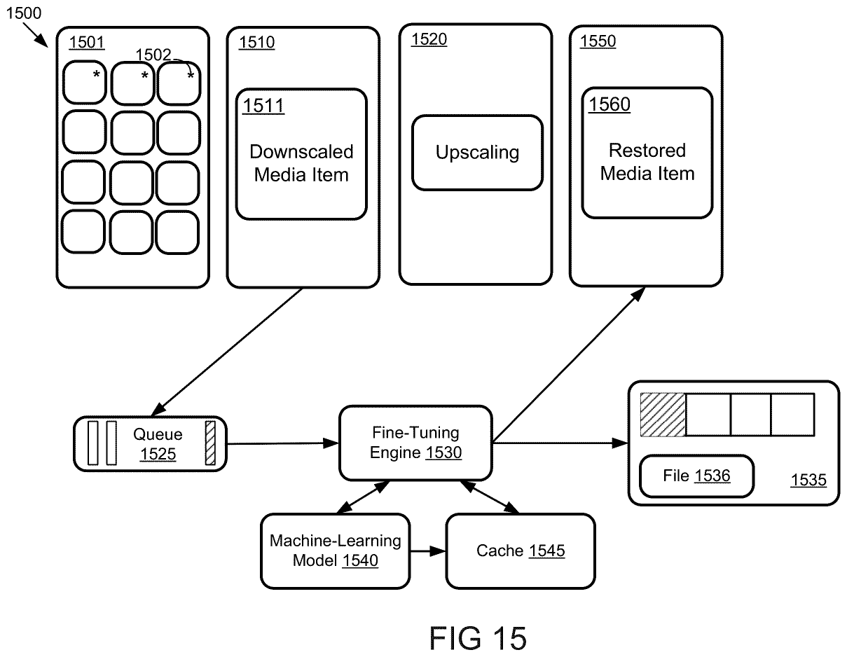

FIG. 15 illustrates a block diagram 1500 of an example process for generating a restored media item, according to some embodiments described herein. A user interface 1501 includes a set of media items. In this example, the downscaled media items are indicated with an asterisk, such as asterisk 1502, but other indicators may be used. A user selects one of the downscaled media items.

The user interface 1510 is updated to display the downscaled media item 1511 selected by the user. The user selects an option for generating a restored media item from the downscaled media item 1511. While the process of generating the restored media item is occurring, the user interface 1520 is updated to display a notification that upscaling is occurring.

In some embodiments, such as when multiple downscaled media items are selected for generating restored media items, the downscaled media item 1511 is provided to a queue 1525. The next downscaled media item 1511 that is ready for processing is provided to the fine-tuning engine 1530. In some embodiments, the fine-tuning engine 1530 queries the cloud storage 1535 for the file 1536. The file 1536 represents a cumulative outcome of training each media item within the user's library and is used to enhance the downscaled media item 1511.

The fine-tuning engine 1530 provides the downscaled media item 1511 and the file 1536 to the machine-learning model 1540. The set of modifications to weights that are included in the file are applied to the machine-learning model 1540. In some embodiments, the set of modifications to the weights are applied to each layer of the machine-learning model 1540. In some embodiments, the machine-learning model 1540 includes an array of machine-learning models 1540. For example, a first machine-learning model 1540 may be trained to enhance images with text, a second machine-learning model 1540 may be trained to enhance images with faces, etc. In some embodiments, each machine-learning model 1540 is associated with a particular file 1536.

The machine-learning model 1540 generates a restored media item 1560. The restored media item 1560 may be stored in the cache 1545, for example, in case the user decides not to save the restored media item 1560 in cloud storage but requests it again. The machine-learning model 1540 provides the restored media item 1560 to the user interface module, which updates the user interface 1550 to display the restored media item 1560.

### Methods

FIG. 1600 illustrates flowchart of an example method 1600 to generate a high-resolution image after an original image was captured. The method 1600 may be performed by the computing device 200 in FIG. 2. In some embodiments, the method 1600 is performed by the user device 115, the media server 101, or in part on the user device 115 and in part on the media server 101.

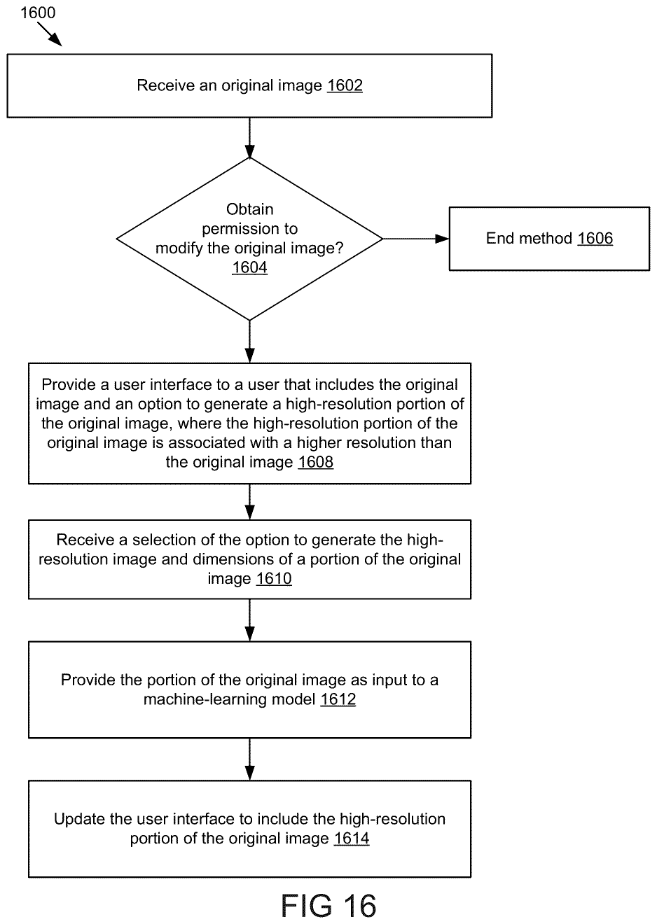

The method 1600 of FIG. 16 may begin at block 1602. At block 1602, an original image is received. The original image may be from a camera associated with a computing device or from a server. Block 1602 may be followed by block 1604.

At block 1604, is it determined whether permission is obtained to modify the original image. If permission is not obtained, block 1604 may be followed by block 1606 to end the method 1600. If permission is obtained, block 1604 may be followed by block 1608.

At block 1608, a user interface is provided to a user that includes the original image and an option to generate a high-resolution image, where the high-resolution portion of the original image is associated with a higher resolution than the original image. Block 1608 may be followed by block 1610.

At block 1610, a selection of the option to generate the high-resolution portion of the original image and dimensions of a portion of the original image are received. In some embodiments, the method 1600 further includes receiving an indication of a corresponding level of magnification for the portion of the original image, where the high-resolution portion of the original image is based on the corresponding level of magnification. Block 1610 may be followed by block 1612.

At block 1612, the portion of the original image is provided as input to a machine-learning model. In some embodiments, the machine-learning model is trained using a combination of multiple losses, a color mismatch loss, and a sharpened perceptual feature loss. In some embodiments, the machine-learning model is trained using training data that includes a lower-resolution image generated from a higher-resolution image by performing one or more operations selected from a group of extracting a random crop of an input image, applying an inverse gamma correction to the input image based on a random gamma correction value, augmenting the input image by randomly shifting pixel values by a constant factor, blurring the input image by adding noise to the input image, applying gamma correction to the input image, and combinations thereof.

In some embodiments, the machine-learning model generates the high-resolution portion of the original image by dividing the portion of the original image into a plurality of tiles; for each tile of the plurality of tiles, generating a super resolution tile that includes one or more of a base super resolution layer, a face super resolution layer, a text super resolution layer, and combinations thereof; and aggregating the super resolution tiles to form the high-resolution portion of the original image. In some embodiments, the machine-learning model generates the high-resolution portion of the original image by determining whether the portion of the original image meets a threshold resolution value and responsive to the portion of the original image failing to meet the threshold resolution value, generating an unblurred portion of the original image and upscaling the unblurred portion of the original image to a target resolution. In some embodiments, the machine-learning model generates the high-resolution portion of the original image by determining whether the portion of the original image meets a threshold resolution value; responsive to the portion of the original image meeting the threshold resolution value, determining whether the portion of the original image includes a face; responsive to the portion of the original image including the face, outputting, with a face super resolution module, a face super resolution layer; and blending the base super resolution layer and the face super resolution layer to form the high-resolution portion of the original image. In some embodiments, the machine-learning model generates the high-resolution portion of the original image by determining whether the portion of the original image meets a threshold resolution value; responsive to the portion of the original image meeting the threshold resolution value, generating a base super resolution layer; determining whether the portion of the original image includes a text; responsive to the portion of the original image including the text, outputting, with a text super resolution module, a text super resolution layer of the original image; and blending the base super resolution layer and the text super resolution layer to form the high-resolution portion of the original image. Block 1612 may be followed by block 1614.

At block 1614, the user interface is updated to include the high-resolution portion of the original image.

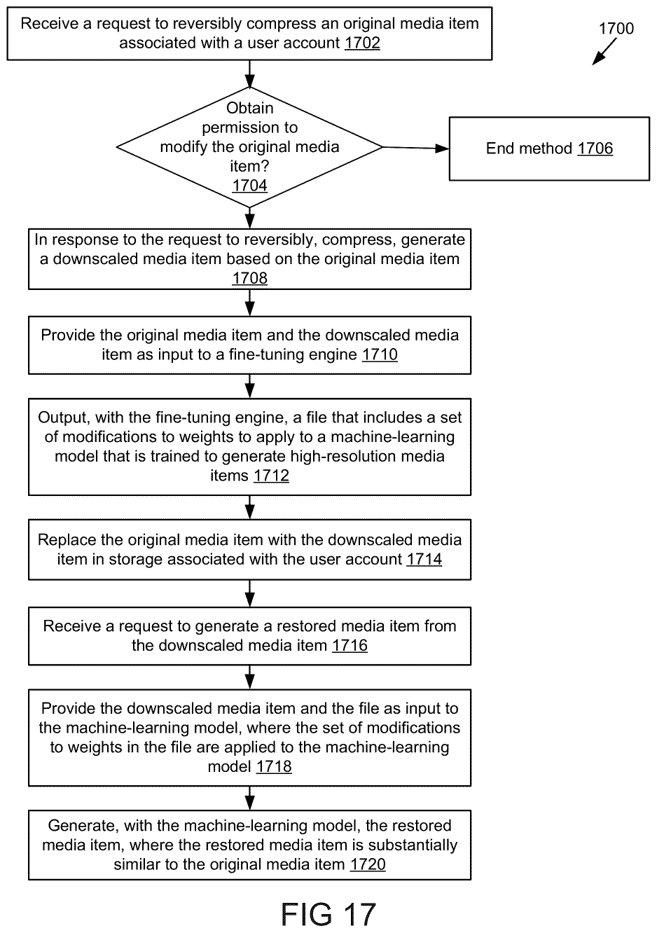

FIG. 17 illustrates a flowchart of an example method 1700 to generate a downscaled media item, according to some embodiments described herein. The method 1700 may be performed by the computing device 200 in FIG. 2. In some embodiments, the method 1700 is performed by the user device 115, the media server 101, or in part on the user device 115 and in part on the media server 101.

The method 1700 of FIG. 17 may begin at block 1702. At block 1702, a request to reversibly compress an original media item associated with a user account is received. The original media item may be an image or video and may be from a camera associated with a computing device or from a server. Block 1702 may be followed by block 1704.

At block 1704, is it determined whether permission is obtained to modify the original media item. If permission is not obtained, block 1704 may be followed by block 1706 to end the method 1700. If permission is obtained, block 1704 may be followed by block 1708.

At block 1708, in response to the request to reversibly compress, a downscaled media item is generated based on the original media item. Block 1708 may be followed by block 1710.

At block 1710, the original media item and the downscaled media item are provided as input to a fine-tuning engine. Block 1710 may be followed by block 1712.

At block 1712, the fine-tuning engine outputs a file that includes a set of modifications to weights to apply to a machine-learning model that is trained to generate high-resolution media items. In some embodiments, prior to the fine-tuning engine outputting the file, the weights of the machine-learning model are frozen, and the fine-tuning engine generates matrices that, when applied to the weights of the machine-learning model, enable the machine-learning model to perform upscaling of the downscaled media item. Block 1712 may be followed by block 1714.

At block 1714, the original media item is replaced with the downscaled media item in storage associated with the user account. The storage may be part of a user device and/or cloud storage. Block 1714 may be followed by block 1716.

At block 1716, a request to generate a restored media item from the downscaled media item is received. Block 1716 may be followed by block 1718.

At block 1718, in response to the request to generate the restored media item, the downscaled media item and the file are provided as input to the machine-learning model, where the set of modifications to weights in the file are applied to the machine-learning model. Block 1718 may be followed by block 1720.

At block 1720, the machine-learning model generates the restored media item based on the downscaled media item and the file, where the restored media item is substantially similar to the original media item. For example, the restored media item may have a similar size and resolution as the original media item and, in some embodiments, may have a higher quality than the original media item.

In some embodiments, the machine-learning model generates the restored media item by: dividing the downscaled media item into a plurality of tiles; for each tile of the plurality of tiles, generating a super resolution tile that includes one or more of a base super resolution layer, a face super resolution layer, a text super resolution layer, and combinations thereof, where the set of modification to the weights are applied to each corresponding layer during generation of each tile; and aggregating the super resolution tiles to form the restored media item. In some embodiments, the machine-learning model generates the restored media item by: generating a base super resolution layer; determining whether the downscaled media item includes a face; responsive to the downscaled media item including the face, outputting a face super resolution layer; and blending the base super resolution layer and the face super resolution layer to form the restored media item. In some embodiments, the machine-learning model generates the restored media item by: generating a base super resolution layer; determining whether the downscaled media item includes text; responsive to the downscaled media item including the text, outputting a text super resolution layer of the downscaled media item; and blending the base super resolution layer and the text super resolution layer to form the restored media item.

For the methods, processes, etc. described herein, various operations can be omitted, combined, modified, supplemented with other operations, performed in an order different than what is shown, etc.

In the above description, for purposes of explanation, numerous specific details are set forth in order to provide a thorough understanding of the specification. It will be apparent, however, that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are used by those of ordinary skill in the data processing arts to most effectively convey the substance of their work to others of ordinary skill in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
receiving a request to reversibly compress an original media item associated with a user account;
in response to the request to reversibly compress, generating a downscaled media item based on the original media item;
providing the original media item and the downscaled media item as input to a fine-tuning engine;
outputting, with the fine-tuning engine, a file that includes a set of modifications to weights to apply to a machine-learning model that is trained to generate high-resolution media items; and
replacing the original media item with the downscaled media item in storage associated with the user account.

2. The method of claim 1, further comprising:
receiving a request to generate a restored media item from the downscaled media item;
in response to the request to generate the restored media item, providing the downscaled media item and the file as input to the machine-learning model, wherein the set of modification to the weights in the file are applied to the machine-learning model; and
generating, with the machine-learning model and based on the downscaled media item and the file, the restored media item, wherein the restored media item is substantially similar to the original media item.

3. The method of claim 2, wherein the machine-learning model generates the restored media item by:
dividing the downscaled media item into a plurality of tiles;
for each tile of the plurality of tiles, generating a super resolution tile that includes one or more of a base super resolution layer, a face super resolution layer, a text super resolution layer, and combinations thereof, wherein the set of modification to the weights are applied to each corresponding layer during generation of each tile; and
aggregating the super resolution tiles to form the restored media item.

4. The method of claim 2, wherein the machine-learning model generates the restored media item by:
generating a base super resolution layer;
determining whether the downscaled media item includes a face;
responsive to the downscaled media item including the face, outputting a face super resolution layer; and
blending the base super resolution layer and the face super resolution layer to form the restored media item.

5. The method of claim 2, wherein the machine-learning model generates the restored media item by:
generating a base super resolution layer;
determining whether the downscaled media item includes text;
responsive to the downscaled media item including the text, outputting a text super resolution layer of the downscaled media item; and
blending the base super resolution layer and the text super resolution layer to form the restored media item.

6. The method of claim 2, wherein generating the downscaled media item includes reducing a size and a resolution of the original media item, and wherein the restored media item is generated to match the size and the resolution of the original media item.

7. The method of claim 1, further comprising:
prior to the fine-tuning engine outputting the file, freezing weights of the machine-learning model; and
wherein the set of modifications to the weights are matrices that, when applied to weights of the machine-learning model, enable the machine-learning model to perform upscaling of the downscaled media item.

8. The method of claim 1, further comprising storing the downscaled media item in cloud storage.

9. The method of claim 1, further comprising generating a user interface that displays media items associated with the user account, wherein the downscaled media item is illustrated with an indicator that the downscaled media item is associated with a lower resolution.

10. A non-transitory computer-readable medium with instructions stored thereon that, when executed by one or more computers, cause the one or more computers to perform operations, the operations comprising:
receiving a request to reversibly compress an original media item associated with a user account;
in response to the request to reversibly compress, generating a downscaled media item based on the original media item;
providing the original media item and the downscaled media item as input to a fine-tuning engine;
outputting, with the fine-tuning engine, a file that includes a set of modifications to weights to apply to a machine-learning model that is trained to generate high-resolution media items; and
replacing the original media item with the downscaled media item in storage associated with the user account.

11. The computer-readable medium of claim 10, wherein the operations further include:
receiving a request to generate a restored media item from the downscaled media item;
in response to the request to generate the restored media item, providing the downscaled media item and the file as input to the machine-learning model, wherein the set of modification to the weights in the file are applied to the machine-learning model; and
generating, with the machine-learning model and based on the downscaled media item and the file, the restored media item, wherein the restored media item is substantially similar to the original media item.

12. The computer-readable medium of claim 11, wherein the machine-learning model generates the restored media item by:
dividing the downscaled media item into a plurality of tiles;
for each tile of the plurality of tiles, generating a super resolution tile that includes one or more of a base super resolution layer, a face super resolution layer, a text super resolution layer, and combinations thereof, wherein the set of modification to the weights are applied to each corresponding layer during generation of each tile; and
aggregating the super resolution tiles to form the restored media item.

13. The computer-readable medium of claim 11, wherein the machine-learning model generates the restored media item by:
generating a base super resolution layer;
determining whether the downscaled media item includes a face;
responsive to the downscaled media item including the face, outputting a face super resolution layer; and
blending the base super resolution layer and the face super resolution layer to form the restored media item.

14. The computer-readable medium of claim 11, wherein the machine-learning model generates the restored media item by:
generating a base super resolution layer;
determining whether the downscaled media item includes text;
responsive to the downscaled media item including the text, outputting a text super resolution layer of the downscaled media item; and
blending the base super resolution layer and the text super resolution layer to form the restored media item.

15. The computer-readable medium of claim 11, wherein generating the downscaled media item includes reducing a size and a resolution of the original media item, and wherein the restored media item is generated to match the size and the resolution of the original media item.

16. A system comprising:
a processor; and
a memory coupled to the processor, with instructions stored thereon that, when executed by the processor, cause the processor to perform operations comprising:
receiving a request to reversibly compress an original media item associated with a user account;
in response to the request to reversibly compress, generating a downscaled media item based on the original media item;
providing the original media item and the downscaled media item as input to a fine-tuning engine;
outputting, with the fine-tuning engine, a file that includes a set of modifications to weights to apply to a machine-learning model that is trained to generate high-resolution media items; and
replacing the original media item with the downscaled media item in storage associated with the user account.

17. The system of claim 16, wherein the operations further include:
receiving a request to generate a restored media item from the downscaled media item;
in response to the request to generate the restored media item and based on the downscaled media item and the file, providing the downscaled media item and the file as input to the machine-learning model, wherein the set of modification to the weights in the file are applied to the machine-learning model; and
generating, with the machine-learning model, the restored media item, wherein the restored media item is substantially similar to the original media item.

18. The system of claim 17, wherein the machine-learning model generates the restored media item by:
dividing the downscaled media item into a plurality of tiles;
for each tile of the plurality of tiles, generating a super resolution tile that includes one or more of a base super resolution layer, a face super resolution layer, a text super resolution layer, and combinations thereof, wherein the set of modification to the weights are applied to each corresponding layer during generation of each tile; and
aggregating the super resolution tiles to form the restored media item.

19. The system of claim 17, wherein the machine-learning model generates the restored media item by:
generating a base super resolution layer;
determining whether the downscaled media item includes a face;
responsive to the downscaled media item including the face, outputting a face super resolution layer; and
blending the base super resolution layer and the face super resolution layer to form the restored media item.

20. The system of claim 17, wherein the machine-learning model generates the restored media item by:
generating a base super resolution layer;
determining whether the downscaled media item includes text;
responsive to the downscaled media item including the text, outputting a text super resolution layer of the downscaled media item; and
blending the base super resolution layer and the text super resolution layer to form the restored media item.
